(19) United States
(12) Patent Application Publication
(10) Pub. No.: US 2025/0361087 A1
(43) Pub. Date: Nov. 27, 2025

(54) STORAGE AND RETRIEVAL SYSTEM

(71) Applicant: Ocado Innovation Limited, Hatfield (GB)

(72) Inventors: Wayne MORAN, Hatfield (GB); Paul BEATTIE, Hatfield (GB)

(21) Appl. No.: 19/294,770

(22) Filed: Aug. 8, 2025

Related U.S. Application Data
(63) Continuation of application No. PCT/EP2024/053520, filed on Feb. 12, 2024.

(30) Foreign Application Priority Data
Feb. 10, 2023 (GB) 2301931.8
Jun. 28, 2023 (GB) 2309779.3

(51) Int. Cl. B65G 1/04; B65G 1/06; F25D 13/04

(52) U.S. Cl. CPC B65G 1/0478; B65G 1/0464; B65G 1/065; F25D 13/04; F25D 2317/0411

(57) ABSTRACT

A storage and retrieval system comprising: a first zone comprising a storage structure, the storage structure comprising: a plurality of horizontal members arranged to form a grid pattern defining a plurality of grid cells; a plurality of upright members configured to support the horizontal members from below to define a storage area below the grid cells for storing stacks of storage containers; a second zone separated from the first zone by a divider, the divider comprising an opening such that the first and second zones are in fluid communication; a passage extending from an associated grid cell of the storage structure into the second zone via the opening in the divider such that a storage container can move between the first and second zones via the passage; and a dehumidifier system configured to draw and dehumidify air from the second zone and discharge the air into the first zone.

### CROSS-REFERENCE TO RELATED APPLICATIONS

This application is a continuation of PCT International Patent Application No. PCT/EP2024/053520, filed on Feb. 12, 2024, which claims priority to UK Patent Application No. GB2309779.3, filed on Jun. 28, 2023, which claims priority to UK Patent Application No. GB2301931.8, filed on Feb. 10, 2023, the entire contents of each of which are hereby incorporated by reference.

### TECHNICAL FIELD

The present invention relates to storage and retrieval systems comprising robotic load handling devices that operate on a storage structure for handling storage containers stacked in the storage structure.

### BACKGROUND

Some commercial and industrial activities require systems that enable the storage and retrieval of a large number of different products. WO2015019055A1 describes a storage and retrieval system in which items are stored in storage containers and the storage containers are arranged in stacks within a storage structure. The system further comprises remotely operated load handling devices configured to move on tracks located on the top of the storage structure. To pick up or drop off storage containers stored in the storage structure, each load handling device is equipped with a gripper device for releasably holding a storage container, and a lifting assembly for raising and lowering the gripper device. To fulfil customer orders, storage containers containing the ordered products are picked up from the storage structure and dropped off at a picking station where the ordered products are taken out of the storage containers and placed into delivery containers. The storage containers are then picked up from the picking station and returned to storage in the storage structure. The picking stations are typically located below or immediately adjacent to a portion of the storage structure such that storage containers can be moved efficiently between the storage structure and the picking stations.

Within the context of a grocery selling business, it is desirable to automate the storage and retrieval of a wide range of food items. While the above storage and retrieval system has been commonly deployed for the storage and retrieval of ambient food items and chilled food items, there are challenges associated with the automated storage and retrieval of frozen food items, which require lower temperatures than ambient and chilled goods for safe storage (typically −18° C. or lower). For example, while the environment in an isolated freezer might be relatively straightforward to control, a freezer section within in a wider storage and retrieval system might be open to other sections of the system that are operating in different environments and the freezer section may therefore be more difficult to control. There may also be issues relating to comfort and health and safety of human workers when working at freezing temperatures.

### SUMMARY

The present invention provides a storage and retrieval system comprising: a first zone comprising a storage structure, the storage structure comprising: a plurality of horizontal members arranged to form a grid pattern defining a plurality of grid cells; a plurality of upright members configured to support the horizontal members from below to define a storage area below the grid cells for storing stacks of storage containers; a second zone separated from the first zone by a divider, wherein the divider comprises an opening such that the first zone is in fluid communication with the second zone; a passage extending from an associated grid cell of the storage structure into the second zone via the opening in the divider such that a storage container can be moved between the first zone and the second zone via the passage; and a dehumidifier system configured to draw and dehumidify air from the second zone and discharge the dehumidified air into the first zone.

The storage and retrieval system may further comprise a temperature control system configured to maintain a first air temperature in the first zone and a second air temperature in the second zone. The second air temperature may be higher than the first air temperature. This is particularly advantageous because human workers can work at a comfortable temperature in the second zone, which is remote from the first zone. The dry air output from the dehumidifier system may be pumped into the second zone.

The first air temperature may be between −30° C. and 0° C. The first air temperature may be between −30° C. and −18° C.

The second air temperature may be between −10° C. and +8° C. The second air temperature may be between −10° C. and 0° C., e.g. about −5° C.

The temperature control system may comprise a refrigeration system for maintaining the first air temperature in the first zone.

The temperature control system may comprise a heating system configured to maintain the second air temperature in the second zone.

Optionally, the dehumidifier system may comprise a dehumidifier unit in the first zone and a dehumidifier unit in the second zone.

The dehumidifier system may be configured to dehumidify the air drawn from the second zone such that the dew point of the discharged air is lower than the first air temperature.

The dehumidifier system may be configured to discharge the dehumidified air into the first zone at a rate such that a positive air pressure is generated in the first zone relative to the second zone.

The dehumidifier system may be further configured to draw air from the passage, dehumidify the air drawn from the passage and discharge the dehumidified air into the first zone.

The dehumidifier system may be configured to draw and mix the air from the passage and from the second zone in predetermined proportions. For example, 10%-30% (e.g. about 20%) of the air drawn by the dehumidifier system may be from the passage. Accordingly, 90%-70% (e.g. about 80%) of the air drawn by the dehumidifier system may be from the second zone.

The second zone may be below at least a portion of the first zone. The second zone may be below at least a portion of the storage structure in the first zone. The passage may extend vertically from its associated grid cell into the second zone. The divider may be a horizontal divider (e.g. a floor).

The second zone may be horizontally adjacent to the first zone. The passage may extend vertically from its associated grid cell and then horizontally (or a direction between vertical and horizontal) into the second zone. For example, the passage may comprise an L-shaped passage such that containers can be moved vertically within a vertical portion of the passage and horizontally within a horizontal portion of the passage. The horizontal portion of the passage may extend from the vertical portion of the passage by the length of at least one storage container. The divider may be a vertical divider.

The second zone may comprise a container station for receiving storage containers such that items can be moved into or out of individual storage containers. The passage may extend from its associated grid cell to the container station such that a storage container can be moved between the storage structure and the container station via the passage.

The passage may be at least partially defined by a chute. The chute may be formed from a vertical portion of the passage. The chute be located within the second zone. The chute may extend from the divider into the second zone, e.g. to a container station. The passage may comprise a horizontal portion in communication with the vertical portion of the passage. The horizontal portion comprises a conveyor extending from the vertical portion to an inventory handling station. The horizontal portion may extend by a distance equal to the length of at least one storage container, for example, two, three, four or five storage containers. In this context, the ‘length’ is defined as the longest side of the storage container. Thus, multiple storage containers may be accommodated within the passage.

The passage may comprise a barrier for selectively opening and closing the passage. The barrier may open and close horizontally. In particular, the barrier may open and close horizontally within a vertical portion of the passage. The barrier may open and close vertically. In particular, the barrier may open and close vertically within a horizontal portion of the passage.

The barrier may comprise at least one door moveable between a closed configuration to prevent the ingress of warm air from the second zone into the first zone and an open configuration to permit one or more storage container to move through the passage between the first zone and the second zone. The at least one door may be a roller door, segmented door or a tilt door.

Alternatively or additionally, the barrier may comprise an air curtain unit to provide an air curtain across an opening in the passage.

At least a portion of the passage may be surrounded by a thermally insulating material. The thermally insulating material may extend from the divider to the barrier. The barrier may join on one side to the thermally insulating material. The thermally insulating material may comprise silica aerogel.

The first zone may be an enclosed area. The first zone may comprise a floor, a plurality of walls and a ceiling to define the enclosed area. The second zone may be an enclosed area. The second zone may comprise a floor, a plurality of walls and a ceiling to define the enclosed area.

The storage and retrieval system may comprise a plurality of passages. The divider may comprise a plurality of openings. Each passage may extend from an associated grid cell into the second zone via a respective opening.

The storage structure may further comprise a track structure located on top of the horizontal members. The track structure may further comprise a plurality of tracks arranged to form a grid pattern corresponding to the grid pattern formed by the horizontal members.

The storage and retrieval system may further comprise one or more load handling devices. Each load handling device may comprise: a driving assembly configured to move the load handling device on the track structure; a container-holding assembly configured to releasably hold a storage container from above; and a lifting assembly configured to raise and lower the container-holding assembly to allow the load handling device to lift and lower storage containers into and out of the storage structure and passage via the grid cells.

### DESCRIPTION OF THE DRAWINGS

The present invention will now be described, by way of example only, with reference to the accompanying drawings, in which:

FIG. 1 is a schematic side view of a storage and retrieval system comprising a first zone and a second zone.

FIG. 2 is a schematic perspective view of a storage structure located within the first zone with containers arranged within the storage structure and load handling devices on top of the storage structure.

FIG. 3 is a schematic plan view of a track structure on top of the storage structure.

FIG. 4 is a schematic perspective view of a load handling device with a container-holding assembly in a position below the bottom of the load handling device.

FIG. 5 is a schematic perspective view of the load handling device of FIG. 4 with a side portion of the external body omitted from view to show a container-receiving space.

FIG. 6 is a schematic perspective view of the load handling device of FIG. 5 with a container occupying the container-receiving space.

FIG. 7 is a schematic diagram of the storage and retrieval system showing the first zone, the second zone and a dehumidifier system.

FIG. 8 is a schematic side view of a storage and retrieval system comprising a first zone and a second zone in an alternative arrangement to the arrangement shown in FIG. 1.

FIG. 9 is a schematic side view of a storage and retrieval system comprising a first zone and a second zone in an alternative arrangement to the arrangement shown in FIG. 1.

FIGS. 10A-10C show a schematic side view of double doors in the passage between the first and second zones. FIG. 10A shows a closed configuration; FIG. 10B shows a partially open configuration; and FIG. 10C shows an open configuration.

FIGS. 11A-11C show a schematic side view of a tilt door in a horizontal portion of the passage between the first and second zones. FIG. 11A shows a closed configuration; FIG. 11B shows a partially open configuration; and FIG. 11C shows an open configuration.

FIGS. 12A-12C show a schematic side view of a horizontally segmented door in a horizontal portion of the passage between the first and second zones. FIG. 12A shows a closed configuration; FIG. 12B shows a partially open configuration; and FIG. 12C shows an open configuration.

### DETAILED DESCRIPTION

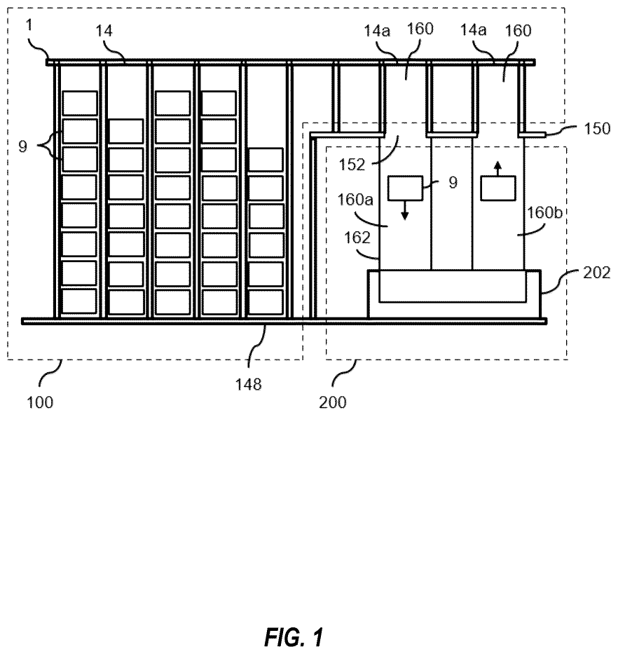

FIG. 1 shows a schematic side view of a storage and retrieval system for storing and retrieving frozen goods (e.g. frozen grocery items) that are held in storage containers 9. The storage and retrieval system comprises a first zone 100 for storing the storage containers within a storage structure 1, and a second zone 200 for accessing individual storage containers moved out of the first zone 100 and/or accessing individual storage containers which are to be moved into the first zone 100.

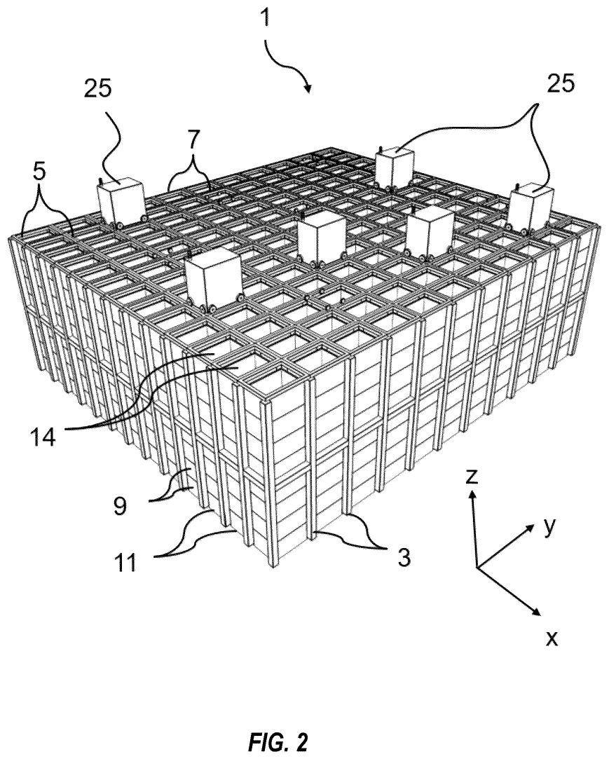

FIG. 2 shows an example storage structure 1 for storing storage containers 9 in the first zone 100. The storage structure 1 comprises a framework comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells 14.

The storage structure 1 defines a storage space under the horizontal members 5, 7 comprising a plurality of storage columns, each storage column being located below a respective grid cell 14. Each storage column can accommodate a vertical stack 11 of storage containers. Under one or more other grid cells 14a (shown in FIG. 1), hereafter referred to as “port cells” 14a, the storage structure 1 further defines port columns, each column being located below a respective port cell 14a. Each port column at least partially defines a passage 160 for allowing storage containers 9 to be transported between the storage structure 1 in the first zone 100 and container stations 202 in the second zone 200, as shown in FIG. 1.

The second zone 200 comprises one or more container stations 202. Each container station 202 is configured to receive storage containers 9 and present them individually such that items can be moved into or out of the storage containers 9. One example type of container station 202 is a picking station at which storage containers 9 are received from the storage structure 1 and customer orders are prepared by picking items out of the storage containers 9 and placing them into a delivery receptacle such as a container or a bag. Another example type of a container station 202 is a stocking station at which items are placed into empty storage containers 9 for storage in the storage structure 1. Other examples of container stations 202 at which storage containers 9 are received from the storage structure 1 and/or moved into storage structure are also possible. The second zone 200 may comprise a single type of container station 202 or a plurality of types of container station 202.

In the illustrated example shown in FIG. 1, the second zone 200 is located directly below an overhead portion of the storage structure 1 and is separated from the first zone 100 by a divider 150. More specifically, the storage and retrieval system comprises a horizontal base floor 148 which defines the floor of the first zone 100 and the floor of the second zone 200, and the divider 150 is in the form of a horizontal mezzanine floor located above the horizontal base floor 148. A main portion of the storage structure 1 is supported on the horizontal base floor 148 and the overhead portion is supported on the divider 150. The second zone 200 may be further separated from the first zone 100 by one or more vertical walls to define an enclosed area. The first zone 100 may also comprise walls and a ceiling to define an enclosed area around the storage structure 1.

As mentioned above, the storage and retrieval system comprises one or more passages 160 for allowing the transport of storage containers 9 between the storage structure and the container stations 202. Each passage 160 extends vertically downwards from its associated port cell 14a to a container station 202 via an opening 152 in the divider 150.

Each container station 202 may have one or more passages 160 leading to it. In FIG. 1, the illustrated container station 202 has two passages 160 leading to it-a drop-off passage 160a through which a storage container 9 is moved from the storage structure 1 to the container station 202 and a pick-up passage 160b through which a storage container 9 is moved from the container station 202 to the storage structure 1. In the context of a picking station, the drop-off passage 160a may be used to drop-off a storage container 9 containing a product that has been ordered by a customer and the pick-up passage 160b may be used to pick up the storage container 9 after the product has been taken out of the storage container 9 in order to return the storage container 9 to the storage structure 1. A container station 202 may comprise one or more conveyors for moving a storage container 9 between a drop-off passage 160a and a pick-up passage 160b. Other container stations 202 may only have one passage 160 leading to it. For example, a stocking station may only have a pick-up passage 160b leading to it for allowing storage containers 9 that have just been filled with new stock to be moved into the storage structure 1. Other configurations of passages 160 for each container station 202 are also possible. Each container station 202 may have one or more passages 160 associated with it, and each of those passages may be a different type of passage 160, e.g. a drop-off passage, a pick-up passage or a passage that functions as a combined drop-off and pick-up passage. To increase throughput, a container station 202 could have a plurality of a particular type of passage 160 associated with it.

Each passage 160 may be at least partially defined by a chute 162, i.e. a tubular structure surrounding the passage 160. Each chute 162 is preferably arranged in the second zone 200, e.g. between the divider 150 and a container station 202, as shown in FIG. 1, but could also extend all the way between a port cell 14a and a container station 202.

Referring back to FIG. 2, storage containers 9 are moved between the storage structure 1 and the container stations 202 using load handling devices 25, hereafter referred to as “bots”, which operate on top of the storage structure 1. In particular, the bots 25 are configured to move on tracks on top of the storage structure 1 and lift and lower storage containers through the grid cells 14, as will now be described in further detail.

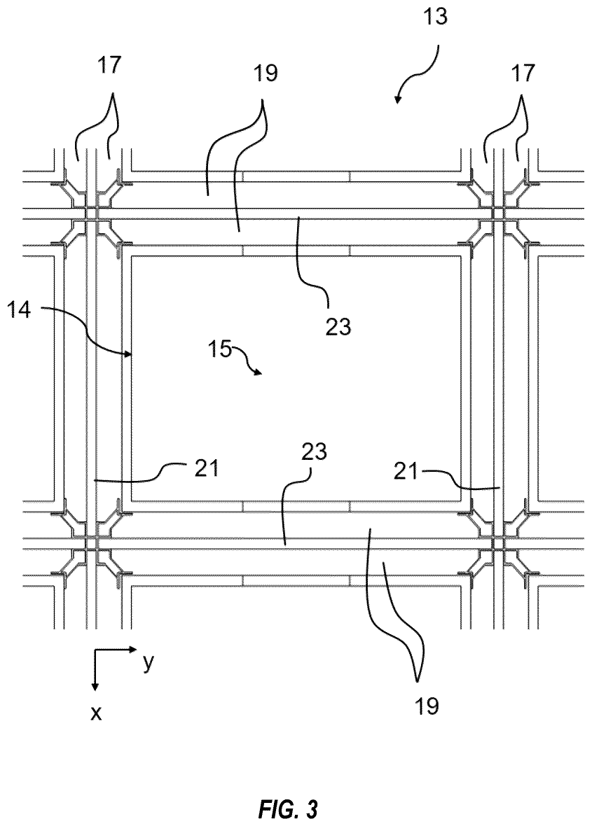

FIG. 3 shows a large-scale plan view of a section of track structure 13 forming part of the storage structure 1 illustrated in FIG. 1 and located on top of the horizontal members 5, 7 of the storage structure 1 illustrated in FIG. 2. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centers of the grid cells 14. The apertures 15 are sized to allow storage containers 9 located beneath the grid cells 14 to be lifted and lowered through the apertures 15. The x-direction tracks 17 are provided in pairs separated by channels 21, and the y-direction tracks 19 are provided in pairs separated by channels 23. Other arrangements of track structure may also be possible. The bots 25 are provided with sets of wheels to engage with corresponding x- or y-direction tracks 17, 19 to enable the bots 25 to travel across the track structure 13 and reach specific grid cells 14. The illustrated pairs of tracks 17, 19 separated by channels 21, 23 allow bots 25 to occupy (or pass one another on) neighboring grid cells 14 without colliding with one another.

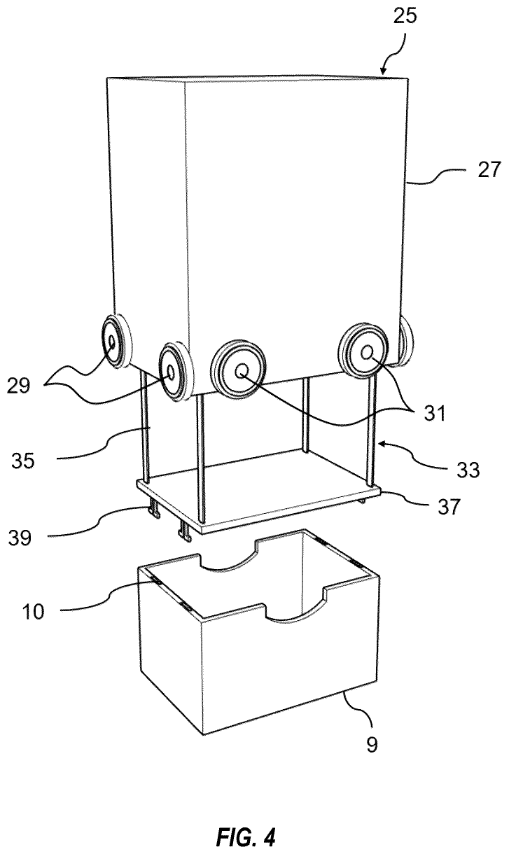

As illustrated in FIG. 4, a bot 25 comprises an external body 27 in or on which are mounted one or more components which enable the bot 25 to perform its intended functions. These functions may include moving across the storage structure 1 on the track structure 13 and raising or lowering storage containers 9 though the grid cells 14 so that the bot 25 can retrieve or deposit storage containers 9 in specific locations defined by the grid pattern.

The illustrated bot 25 comprises a driving assembly comprising first and second sets of wheels 29, 31 which are mounted on the external body 27 of the bot 25 and enable the bot 25 to move in the x- and y-directions along the tracks 17 and 19, respectively. In particular, two wheels 29 are provided on the shorter side of the bot 25 visible in FIG. 4, and a further two wheels 29 are provided on the opposite shorter side of the bot 25. The wheels 29 engage with tracks 17 and are rotatably mounted on the external body 27 of the bot 25 to allow the bot 25 to move along the tracks 17. Analogously, two wheels 31 are provided on the longer side of the bot 25 visible in FIG. 4, and a further two wheels 31 are provided on the opposite longer side of the bot 25. The wheels 31 engage with tracks 19 and are rotatably mounted on the external body 27 of the bot 25 to allow the bot 25 to move along the tracks 19.

To enable the bot 25 to move on the different wheels 29, 31 in the first and second directions, the driving assembly further comprises a wheel-positioning mechanism (not shown) for selectively engaging either the first set of wheels 29 with the first set of tracks 17 or the second set of wheels 31 with the second set of tracks 19. The wheel-positioning mechanism is configured to raise and lower the first set of wheels 29 and/or the second set of wheels 31 relative to the external body 27, thereby enabling the bot 25 to selectively move in either the first direction or the second direction across the tracks 17, 19 of the storage structure 1.

The wheel-positioning mechanism may include one or more linear actuators, rotary components or other means for raising and lowering at least one set of wheels 29, 31 relative to the external body 27 of the bot 25 to bring the at least one set of wheels 29, 31 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the external body 27 of the bot 25 stays substantially at the same height and therefore the weight of the external body 27 and the components mounted thereon does not need to be lifted and lowered by the wheel-positioning mechanism.

The bot 25 also comprises a lifting assembly 33 and a container-holding assembly 37 configured to raise and lower storage containers 9. The illustrated lifting assembly 33 comprises four tethers 35 which are connected at their lower ends to the container-holding assembly 37. The tethers 35 may be in the form of cables, ropes, tapes, or any other form of tether with the necessary physical properties to lift the storage containers 9. The container-holding assembly 37 comprises a gripping mechanism 39 configured to engage with features of the storage containers 9 to releasably hold the containers 9 from above. In the illustrated example, the gripping mechanism 39 comprises legs that can be received in corresponding apertures 10 in the rim of the storage container 9 and then moved outwards to engage with the underside of the rim of the storage container 9. The tethers 35 can be wound up or down to raise or lower the container-holding assembly 37 as required. One or more motors and winches or other means may be provided to effect or control the winding up or down of the tethers 35.

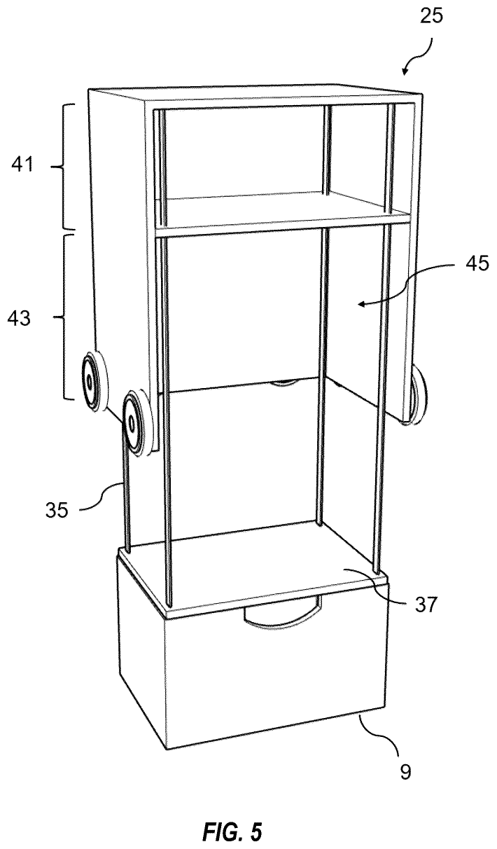

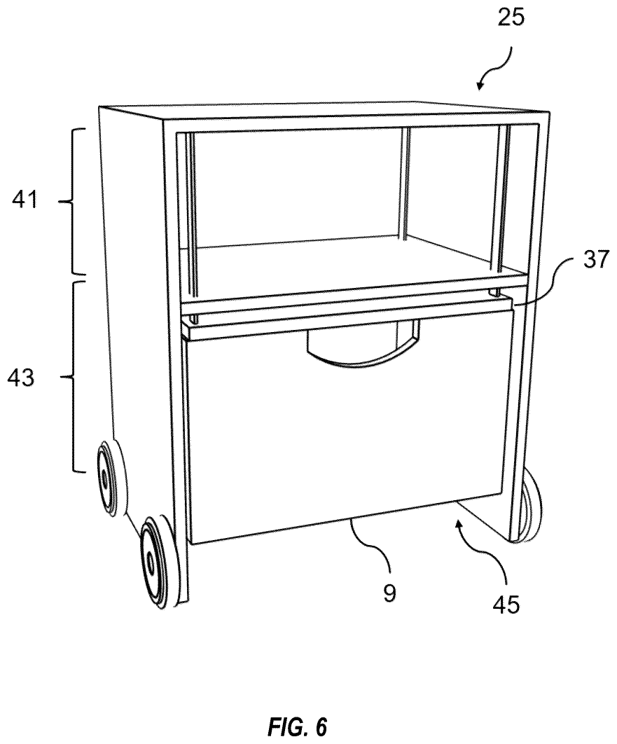

In FIG. 5 and FIG. 6, a side portion of the external body 27 of the bot 25 has been omitted from view to allow the interior of the bot 25 to be seen. The external body 27 of the illustrated bot 25 has an upper portion 41 and a lower portion 43. The upper portion 41 is configured to house or support one or more operation components (not shown), such as components of the lifting assembly 33 (e.g. motors), wireless communication components, a bot control system comprising one or more processors for controlling operation of the bot 25, etc. The lower portion 43 is arranged beneath the upper portion 41. The lower portion 43 is externally open at the bottom and defines a container-receiving space 45 for accommodating at least part of a storage container 9 that has been raised into the container-receiving space 45 by the lifting assembly 33. FIG. 5 shows the container-receiving space 45 before it is occupied by a storage container 9 and FIG. 6 shows the container-receiving space 45 after it has been occupied by a storage container 9. The container-receiving space 45 is sized such that enough of a storage container 9 can fit inside the container-receiving space 45 to enable the bot 25 to move across the track structure 13 on top of storage structure 1 without the underside of the storage container 9 catching on the track structure 13 or another part of the storage structure 1. When the bot 25 has reached its intended destination, the lifting assembly 33 controls the tethers 35 to lower the container-holding assembly 37 and the corresponding storage container 9 out of the container-receiving space 45 and into the intended position. Although in the illustrated example the upper and lower portions 41, 43 are separated by a physical divider, in other examples, the upper and lower portions 41, 43 may not be physically divided by a specific component or part of the external body 27 of the bot 25. The upper and lower configuration of the bot 25 allows the bot 25 to occupy only a single grid cell 14 on the track structure 13 of the storage system 1.

In an alternative example, the container-receiving space 45 of the bot 25 may not be within the external body 27 of the bot 25. For example, the container-receiving space 45 may instead be adjacent to the external body 27 of the bot 25, e.g. in a cantilever arrangement with the weight of the external body 27 of the bot 25 counterbalancing the weight of the container 9 to be lifted. In such embodiments, a frame or arms of the lifting assembly 33 may protrude horizontally from the external body 27 of the bot 25, and the tethers 35 may be arranged at respective locations on the protruding frame/arms and configured to be raised and lowered from those locations to raise and lower a storage container 9 into the container-receiving space 45 adjacent to the external body 27.

To transport a storage container 9 from a stack 11 in the storage structure 1 to a container station 202, a bot 25 picks up a storage container 9 from the top of a stack 11 using its container-holding assembly 37 and lifting assembly 33, moves along the track structure 13 to a port cell 14a, lowers the storage container 9 through the port cell 14a into the passage 160 and then releases the storage container 9 at the container station 202. To transport a storage container 9 from a container station 202 to a stack 11 in the storage structure 1, the operation is carried out in reverse, i.e. the bot 25 lowers its container-holding assembly 37 through a port cell 14a into a passage 160, picks up a storage container 9 at the container station 202, lifts the storage container 9 up through the passage 160 and the port cell 14a, then moves along the track structure 13 to deposit the storage container 9 on top of a stack 11.

Instead of the bots 25 moving storage containers 9 along the whole length of the passages 160, one or more passages 160 could contain a container lift for vertically transporting storage containers 9 within at least a portion of the passage 160. For example, to transport a storage container 9 from the storage structure 1 to a container station 202, the bot 25 may lower a storage container 9 part of the way down the passage 160 and release the storage container 9 onto the container lift. The lift may then move downwards within the passage 160 to transport the storage container 9 the rest of the way to the container station 202. Similarly, to transport the storage container 9 from the container station 202 to the storage structure 1, the lift may receive the storage container 9 at the container station 202 and move upwards within the passage 160 to a predetermined position along the passage 160 from which a bot 25 can pick up the storage container 9 and lift it the rest of the way out of the passage 160.

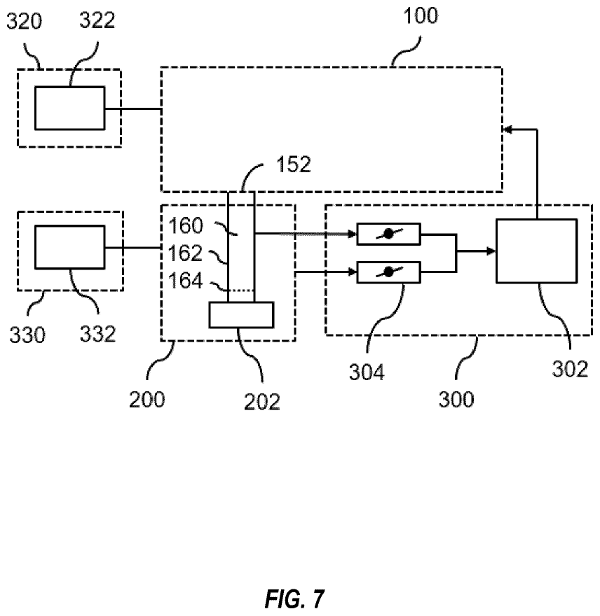

FIG. 7 shows a schematic diagram of the storage and retrieval system including the first zone 100, the second zone 200 and a dehumidifier system 300. As mentioned earlier, the storage and retrieval system can be used to store and retrieve frozen goods. The storage and retrieval system comprises a temperature control system for regulating the air temperature of the first zone 100 and second zone 200. The temperature control system comprises a refrigeration system 320 with one or more refrigeration units 322 with an appropriate control system and temperature sensors for maintaining the air temperature in the first zone 100 at a control temperature (set point) suitable for freezing food items, e.g. below 0° C. For food safety, the control temperature of the first zone 100 is preferably about −18° C. or lower, e.g. between −30° C. and −18° C.

The passages 160 allow storage containers 9 to be efficiently transported between the first zone 100 and the second zone 200 and, for efficiency, are preferably constantly open, at least during operating hours. However, this means that air is able to flow between the first zone 100 and the second zone 200 via the openings 152 in the divider 150, i.e. the first zone 100 and the second zone 200 are in fluid communication via the openings 152. The air temperature in the second zone 200 may therefore, in the absence of any heating, reach a temperature that is similar to the air temperature in the first zone 100. Given that human workers may be present in the second zone 200, e.g. to work at the container stations 202, it is preferable for the air temperature in the second zone 200 to be higher than the air temperature in the first zone 100 to provide a more comfortable working environment for human workers.

Some heating of the second zone 200 may occur during operation (i.e. when the container stations 202 are in operation) due to heat being emitted from the equipment within the second zone 200 (e.g. lights, motors, etc.). Heat may also enter the second zone 200 whenever any doors are opened between the second zone 200 and warmer areas of the storage and retrieval system. If this heat is not enough or cannot be relied upon to heat the second zone 200 to a more comfortable working temperature, then the temperature control system may further comprise a heating system 330 comprising at least one heating unit 332 and a suitable control system with appropriate temperature sensors for maintaining the air temperature in the second zone 200 at a particular control temperature (set point) that is higher than the control temperature in the first zone 100. To balance energy efficiency and comfort, the control temperature of the second zone 200 is preferably between −10° C. and +8° C., preferably between −10° C. and +5° C., preferably between −10° C. and 0° C., preferably about −5° C. To improve the energy efficiency of the heating system 330, the heat source is preferably derived from waste heat generated from the refrigeration system 320, or heat pumps may be used.

During operation of the storage and retrieval system, water vapor in the second zone 200 may increase. This may be due to, for example, the presence of human workers working in the second zone 200. Furthermore, the second zone 200 may comprise one or more access doors to allow access between the second zone 200 and other areas of storage and retrieval system. Every time an access door is opened, moist air may enter the second zone 200 from these other areas. For example, the second zone 200 may be adjacent to a third zone which may be operated at a temperature higher than the control temperature in the second zone 200. For example, the third zone may be operated at a temperature that is suitable for storing and/or handling chilled goods (i.e. goods that need to be stored at refrigerator temperatures), e.g. between 0° C. and 8° C., preferably between 0° C. and 5° C. In other examples, the temperature of the third zone could be operated at a temperature suitable for storing ambient goods (i.e. goods that can be safely stored at room temperature), e.g. between about 15° C. to 25° C. The third zone may have a refrigeration, heating or air conditioning system as appropriate to maintain the third zone at a control temperature according to its use.

Given that there is fluid communication between the first zone 100 and the second zone 200 via the openings 152, warmer, moist air from the second zone 200 will have a tendency to flow into the colder first zone 100 via the openings 152. If the relative humidity of the air in the second zone 200 is high enough, there is a risk of condensation occurring in the first zone 100 due to the air temperature in the first zone 100 being lower than the dew point of the air entering the first zone 100 from the second zone 200. Due to the freezing air temperature in the first zone 100, any condensation occurring in the first zone 100 could result in the undesirable formation of frost or ice on the walls and equipment within the first zone 100.

To mitigate condensation, the storage and retrieval system further comprises a dehumidifier system 300. The dehumidifier system 300 comprises a dehumidifier unit 302 configured to draw air from the second zone 200, dehumidify (i.e. remove moisture from) the air drawn from the second zone 200 and discharge the dehumidified air into the first zone 100. The dehumidifier system 300 may comprise ducting configured to direct air from one or more inlets in the second zone 200 to the dehumidifier unit 302 and ducting configured to direct air from the dehumidifier unit 302 to one or more outlets in the first zone 100. The air may be drawn and discharged using one or more fans. The inlets in the second zone 200 and the outlets in the first zone 100 may be located, for example, in the vicinity of a wall or ceiling of the second zone 200 and the first zone 100 respectively.

The dehumidifier unit 302 may be any suitable type of dehumidifier for working at low temperatures (e.g. below 0° C.), such as a desiccant dehumidifier. Desiccant dehumidifiers typically operate by passing a humid process air stream through a desiccant material (e.g. silica gel) which absorbs moisture from the process air stream passing through it. To regenerate the desiccant material (i.e. remove the absorbed moisture), a regeneration air stream is heated and passed through the desiccant material such that the absorbed moisture is drawn into the regeneration air stream and then vented, e.g. to the outside of a building. To allow the desiccant dehumidifier to operate continuously, the desiccant material is typically contained in a rotating wheel such that a portion of the wheel is passed through the process air stream and another portion of the wheel is passed through the regeneration air stream. In the case where the dehumidifier unit 302 is a desiccant dehumidifier, the regeneration air stream may originate from warmer areas of the storage and retrieval system, e.g. room temperature areas, to improve energy efficiency. The dehumidifier system 300 or the dehumidifier unit 302 itself may optionally comprise a cooling unit for cooling down the process air (before or after the drying process) because the drying process within a desiccant dehumidifier typically results in heat being transferred into the process air steam, which may be undesirable given that the dehumidified air is to be expelled into the first zone 100 which is operating at a lower temperature.

The dehumidifier unit 302 is configured to dehumidify the air drawn from the second zone 200 such that the dew point of the air being discharged into the first zone 100 is lower than the control temperature of the first zone 100. As a safety margin, the dew point of the discharged air is preferably at least two to three degrees Celsius lower than the control temperature of the first zone 100. Given that the refrigeration unit 322 of the refrigeration system 320 may be outputting air that is slightly colder than the control temperature in the first zone 100 to keep the air temperature at the set point, the dew point of the discharged air is preferably lower than the temperature of the air being output by the refrigeration unit 322 in order to minimize the risk of ice forming on and near the refrigeration unit 322. Therefore, as a further safety margin, the dew point of the discharged air is preferably at least two to three degrees Celsius lower than the temperature of the air being output from the refrigeration unit 322. The temperature of the air being output from the refrigeration unit 322 could be measured with a temperature sensor, or a static expected value could be assumed.

To dehumidify the air drawn from the second zone 200 to a particular dew point, the dehumidifier system 300 comprises a control system comprising a humidity sensor for measuring relative humidity (e.g. a capacitive or resistive humidity sensor) and a temperature sensor for measuring air temperature. The control system further comprises a controller to calculate the dew point based on these measurements using known equations that relate dew point, relative humidity and temperature, e.g. the Magnus formula or the Arden Buck equation. The controller can then control the operation of the dehumidifier unit 302 (i.e. control parameters of the dehumidifier unit 302 to increase or decrease moisture absorption) to maintain the dew point of the discharged air at a particular set point. The control system could alternatively be configured to control the operation of the dehumidifier unit 302 to maintain the relative humidity of the discharged air at a particular set point that will result in a dew point that is lower than the control temperature of the first zone 100 (based on calculations performed ahead of time).

The air flow rate of the dehumidifier unit 302 (i.e. the rate at which air is drawn and discharged through the dehumidifier unit 302) is preferably high enough to overcome the air vapor pressure of the air in the second zone 200 such that ingress of air from the second zone 200 into the first zone 100 via the openings 152 is minimized. In other words, the dehumidifier air flow rate is preferably high enough to create a positive pressure in the first zone 100 relative to the second zone 200 to substantially prevent air flowing from the second zone 200 to the first zone 100 via the openings 152. The air flow rate that is required can be determined by calculating the theoretical rate at which air will flow from the second zone 200 to the first zone 100 via the openings 152 due to the temperature differential between the first zone 100 and the second zone 200. This rate can be calculated or approximated based on the total area of the openings 152 between the first zone 100 and the second zone 200 (i.e. total number of openings 152 multiplied by the area of each opening 152) and air velocity values as a function of the temperature differential between two areas.

To provide a high enough air flow rate and/or to provide redundancy in the case of dehumidifier unit failure, the dehumidifier system 300 can comprise a plurality of dehumidifier units 302 configured to draw air from the second zone 200, dehumidify the air drawn from the second zone 200 and discharge the dehumidified air to the first zone 100.

In addition to drawing air from the second zone 200, the dehumidifier unit 302 can be further configured to draw air from the passages 160, e.g. in the vicinity of the openings 152. Drawing air from the passages 160 may help to increase the effect of the positive pressure in the first zone 100 such that the risk of the ingress of air from the second zone 200 into the first zone via the openings 152 is further minimized. The passages 160 are also the closest point at which air from the second zone 200 can enter the first zone 100 and therefore drawing air from the passages 160 further reduces the risk of air ingress. The dehumidifier system 300 may comprise ducting arranged to direct air from each passage 160 to the dehumidifier unit 302. For example, each chute defining a passage 160 may comprise a cut-out and the ducting may connect to the chute 162 at the cut-outs. The dehumidifier system 300 is preferably configured to mix the air from the second zone 200 and the air from the passages 160 and draw the mixed air through the dehumidifier unit 302. The dehumidifier system 300 may draw air from the passages 160 and draw air from the second zone 200 in predetermined proportions. The proportion of the mixed air that has been drawn from the passages 160 is preferably between 10% and 30%, e.g. about 20%. The dehumidifier system 300 may comprise air dampers 304 (e.g. volume control dampers) to control the proportion of air being drawn from the passages 160 and the second zone 200 so that the air is mixed according to the predetermined proportions. In the case where the dehumidifier system 300 comprises a plurality of dehumidifier units 302, each dehumidifier unit 302 may be configured to draw and dehumidify air from a subset of the passages 160.

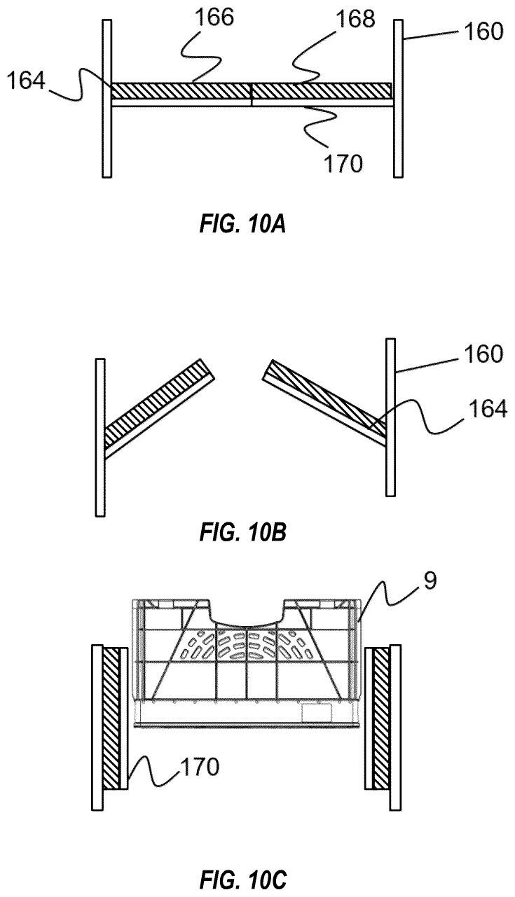

Each passage 160 may also comprise a barrier 164 for selectively blocking and opening the passage 160 such that air flow through the passage 160 is reduced or substantially blocked when the barrier 164 is closed. The barrier 164 may comprise any suitable mechanism for allowing it to be selectively opened and closed, e.g. a hinge or sliding mechanism, and could be operated manually or automated using an actuator and controller. An example of the barrier 164 shown in FIGS. 10A-10C comprises at least one door that is rotatable between a closed configuration to prevent cold air from the first zone 100 entering the second zone 200 (see FIG. 10A) and an open configuration to permit one or more storage containers to move through the passage when moving between the first zone 100 and the second zone 200 (see FIG. 10B). An actuator, e.g. linear solenoid, known in the art can be used to rotate the at least one door between the open and closed configuration. In the particular embodiment of the present invention, the at least one door comprises two doors or double doors or two leaves 166, wherein one of the leaves rotates in a clockwise direction and the other rotates in an anti-clockwise direction to move the double doors between the open and closed configuration. The at least one door comprises suitable insulation to prevent or at least limit the transfer of heat from the second zone into the first zone when the at least one door is in the closed configuration. For example, the door may comprise a thermally insulating jacket. In the particular example shown in FIGS. 10A-10C, each of the two leaves comprises an upper side and a lower side. The upper side of each of the leaves comprises the insulation 168. The lower side of each of the leaves comprises tote guides 170 such that when the at least one door is in the open configuration as shown in FIG. 10C, i.e. in a substantially vertical orientation, the lower side of the doors function to guide the storage containers 9 through the passage 160. In the particular embodiment shown in FIG. 10C, the double doors function to enable the storage container to move up and/or down the passage between the first zone 100 and the second zone 200. To guide the storage containers when the double doors are in the open configuration, the lower side of the doors comprise 90° guide plates for cooperating with the corners of the storage container. The barrier 164 could also be a completely separate object that can be manually inserted into and removed from the passage 160 to substantially block and open the passage 160 respectively. The barrier 164 may comprise a thermally insulating material, e.g. a polymeric foam. The barrier 164 may be located in the second zone 200, e.g. at or near the end of the passage 160 where it enters a container station 202. The purpose of the barrier 164 is to help prevent cold air from the first zone 100 entering the second zone via the passages 160 when the second zone 200 is not in operation, i.e. when the container stations 202 are not in operation, e.g. during system downtime. This is particularly important when the container station 202 in the second zone 200 is not in operation, e.g. during the night. Heat loss from the second zone 200 during non-operating periods can therefore be minimized, which helps to minimize the energy costs of the heating system 330 for maintaining the second zone 200 at its control temperature when the second zone 200 is not in operation, or for bringing the second zone 200 up to temperature if the heating system 330 is switched off during non-operating periods.

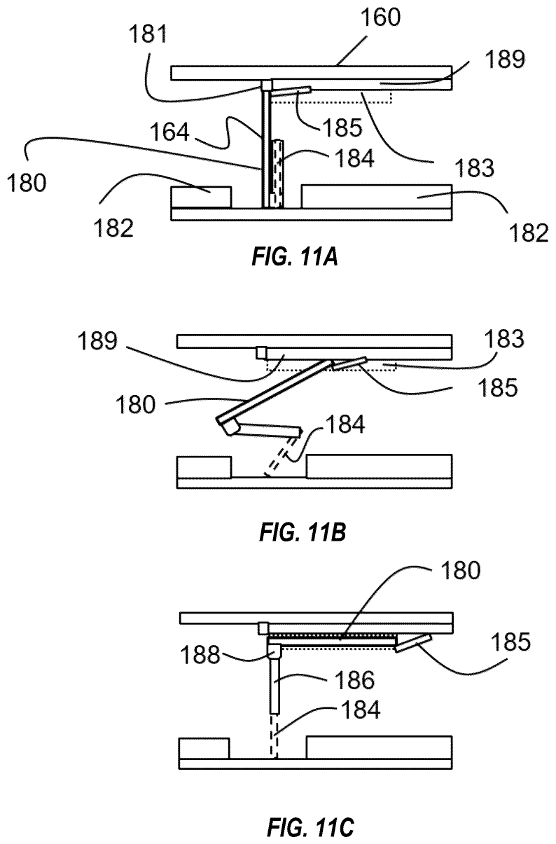

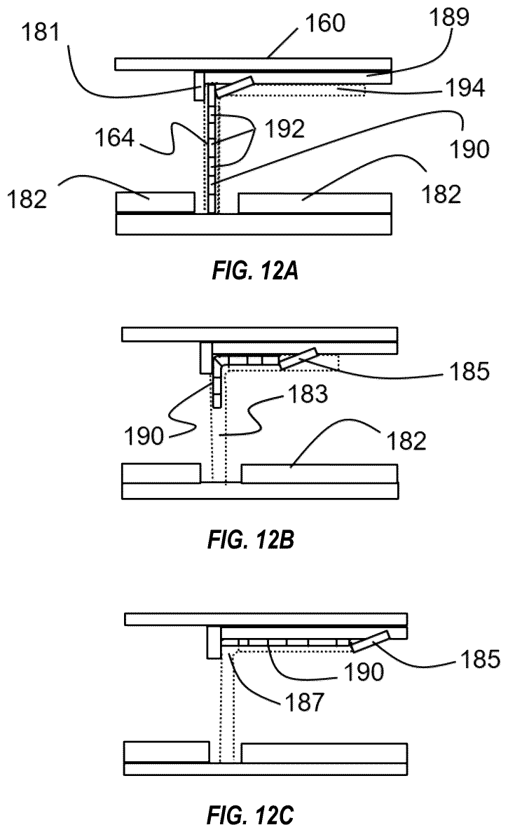

The barrier shown in FIGS. 10A-10C opens and closes horizontally. However, it is also possible for the barrier to open and close vertically as shown in FIGS. 11A-11C and FIGS. 12A-12C. In FIGS. 11A-11C and FIGS. 12A-12C, the barrier 164 is a positioned within a horizontal portion of the passage 160. If one or more conveyors 182 are present within the horizontal portion of the passage 160, as shown in FIGS. 11A-11C and FIGS. 12A-12C, when the barrier 164 is in a closed configuration, the barrier 164 is positioned between adjacent conveyors. Alternatively, when the barrier 164 is in a closed configuration, a base of the barrier 164 can rest on the conveyor 182.

Each barrier in FIGS. 11A-11C and FIGS. 12A-12C comprises a single door or door assembly 180, 190 which opens vertically. The single door or door assembly 180, 190 is moveable between a closed configuration (see FIG. 11A and FIG. 12A) to prevent cold air from the first zone 100 entering the second zone 200, and an open configuration (see FIG. 11C and FIG. 12C) to permit one or more storage containers to move (horizontally) through the passage 160 when moving between the first zone 100 and the second zone 200. In the open configuration, the door 180, 190 is positioned such that it extends in a direction which is perpendicular to the direction in which the door extends when in the closed position. In other words, the door 180, 190 is positioned horizontally at the top of the passage 160 when the door is in the open configuration to permit one or more storage containers to move beneath the open door and through the passage 160 when moving between the first zone 100 and the second zone 200.

FIGS. 11A-11C shows a barrier 164 comprising a tilt up and down door 180. The door 180 is positioned within a door frame 181. The door frame may comprise a thermally insulating material, for example, one side of the door frame may comprise silica aerogel. The door frame 181 extends along the top of the door 180 and along the vertical sides of the door 180 when the door is in the closed configuration, as shown in FIG. 11A. The door 180 moves along a pair of horizontal guides 183. The movement of the door may be facilitated by a resilient member. In FIGS. 11A-11C, the resilient member is two extension springs 184, which are stretched to their longest length when the door 180 is in the closed configuration, as shown in FIG. 11A. The bottom of the extension springs 184 are held stationary and the top of the springs are each secured to one of two lever arms 186. Each lever arm 186 is connected to the door 180 by a connection piece 188 to allow the lever arm 186 to pivot around the connection piece at or near the bottom of the door 180. As the door is activated to open it, a motor (not shown) causes a belt drive 189 to circulate. An arm 185 is attached at one end to the top of the door 180 and at an opposing end to the drive belt 189, such that when the drive belt is circulated, the arm 185 is moved to pull the door 180 into an open configuration (as shown in FIG. 11C) and the extension springs 184 contract and help lift the weight of the door. Conversely, if the drive belt is circulated in an opposing direction, the arm 185 is moved to push the door 180 into a closed configuration (as shown in FIG. 11A) and the extension springs 184 are driven into extension. As shown in FIG. 11B, when the door 180 is moving into the closed configuration or into the open configuration, the door tilts upwards and downwards in a diagonal motion. Whilst the extension springs are useful in lifting the weight of the door because the spring is biased towards the open configuration, it is not necessary to have the springs if the motor is of sufficient power to overcome to weight of the door.

The barrier 164 in FIGS. 12A-12C comprises a roller door. In particular, the roller door of FIGS. 12A-12C is a horizontally segmented or sectional door 190 which opens and closes vertically. The door 190 is positioned within a door frame 181. The door frame may comprise a thermally insulating material, for example, one side of the door frame may comprise silica aerogel. The door frame 181 extends along the top of the door 190 and along the vertical sides of the door 190 when the door is in the closed configuration, as shown in FIG. 12A. There are 7 segments 192 shown in the door 190 of FIGS. 12A-12C but there may be between 3 and 5, or between 6 and 8 or between 9 and 12 segments, or more than 13 segments. Linear bearings (not shown) are attached to the segments 192 and allow the bearings to run along one or more guides 183. In FIG. 12, the one or more guides is a single guide which comprises a vertical portion, a horizontal portion 194 and a curved portion 187, but it is possible to have portions of the guide as separate guides. The curved portion 187 is positioned between the vertical portion and the horizontal portion 194 to allow the segmented door 190 to move from a vertical orientation (as shown in FIG. 12A) to horizontal orientation (as shown in FIG. 12C) and vice versa. FIG. 12A shows the closed configuration of the door, and FIG. 12B shows the door in a partially open configuration, whereby a portion of the segments 192 have been moved into the horizontal portion 194 of the guide 183. The radius of curvature of the door 190 when undergoing changes in orientation or direction is determined by the segment size and configuration of the segments 192. A high radius of curvature requires the segment size to be smaller, whilst a low radius of curvature can be achieved with a larger segment size. In order to move the door 190 from closed configuration (shown in FIG. 12A) to the open configuration (shown in FIG. 12C), a motor (not shown) causes a belt drive 189 to circulate. An arm 185 is attached at one end to the top of the door 190 and an opposing end of the arm 185 is connected to the drive belt 189, such that when the drive belt 189 is rotated in one direction, the arm 185 is moved to pull the door 190 upwards along the guide 183 such that the door 190 gradually moves into the horizontal portion of the guide (as shown in FIG. 12B) and then into the open configuration (as shown in FIG. 12C). Conversely, if the drive belt 189 is circulated in an opposing direction, the arm 185 is moved to push the door 190 into a closed configuration (as shown in FIG. 12A). Instead of moving the door 190 into the horizontal portion of the guide 183, the door 190 may alternatively be wound around a spool at the top of the passage.

The belt drive 189 in FIGS. 11A-12C comprises a rubber belt, preferably a steel-reinforced rubber belt. A chain belt may alternatively be used. The door 180, 190 of FIGS. 11A-12C can be driven by a rotary motor, a gear screw, a stepper motor, linear motor, DC or AC motor. The motor may be mounted directly onto the door, or at the top or bottom of the passage 160. The door can be locked in the closed configuration or the open configuration by a shot bolt, an electromagnet, an electro clutch or any other known mechanism.

Alternatively or in addition to the at least one door, the barrier 164 can comprise an air curtain unit (not shown) producing a stream of air across the passage 160 to create an air door. The air curtain unit can be arranged in the passage 160 having an inlet extending into the passage for drawing cold air either from the first zone or the second zone and an outlet comprising a nozzle configured to direct cold air across the passage 160 to create a seal or air curtain across the passage. The air curtain separates the different temperature environments of the first zone 100 and the second zone 200 whilst allowing a smooth, uninterrupted flow of storage containers up and/or down the passage 160. Like the physical door, the air curtain also prevents cold air from the first zone 100 entering the second zone 200. One advantage of using an air curtain over a physically opening door is that fewer moving parts are required reducing the risk of mechanical failure. Another advantage of using an air curtain is that it is more time efficient as there is no need to wait for the physical door to open or close.

Each passage 160 may also be thermally insulated along at least a portion of its length. For example, each passage 160 may be thermally insulated along a portion that is within the second zone 200. In the case where the passage 160 is defined by a chute 162, the walls of the chute 162 may be clad in a thermally insulating material, e.g. a polymeric foam, or the walls themselves may be made from a thermally insulating material. In the case where each passage 160 comprises a barrier 164, the chute 162 may be insulated from the divider 150 down to the position at which the barrier 164 is located in order to further help prevent cold air from leaking from the first zone 100 into the second zone 200 during periods of non-operation. The insulation may also help to prevent moist air in the second zone 200 condensing on the outside of the chutes 162, as without the insulation, the temperature of the outside of the chutes 162 may be at a similar temperature to the air temperature in the first zone 100 due to the proximity of the chutes 162 to the first zone 100, and may therefore be at a temperature below the dew point of the air in the second zone 200.

The divider 150 and/or any other walls separating the second zone 200 from the first zone 100 may also comprise a thermally insulating material to further thermally insulate the second zone 200 from the first zone 100 to reduce the energy costs of the heating system 330.

The storage and retrieval system described above therefore helps to overcomes issues relating to the storage and retrieval of frozen goods where a freezer-temperature zone (first zone 100) is in fluid communication with a warmer, potentially moister area (second zone 200). In particular, by discharging dehumidified air into the first zone 100, the first zone 100 can be kept dry enough to minimize the risk of frost and ice formation. Furthermore, by drawing air from the second zone 200 and the passages 160 and discharging air into the first zone 100, a positive pressure in the first zone 100 can be created to reduce the risk of ingress of moist air from the second zone 200 into the first zone 100. In addition, the dehumidified air being discharged into the first zone 100 will also circulate back in the second zone 200 via the openings 152, thereby lowering the relative humidity in the second zone 200 and reducing the risk of condensation in the second zone 200. As a result of these effects, the second zone 200 can be kept at a warmer temperature than the first zone 100 to provide a more comfortable working environment for human workers.

The present invention is not limited to the precise forms described above and various modifications and variations falling within the scope of the claims will be apparent to the skilled person.

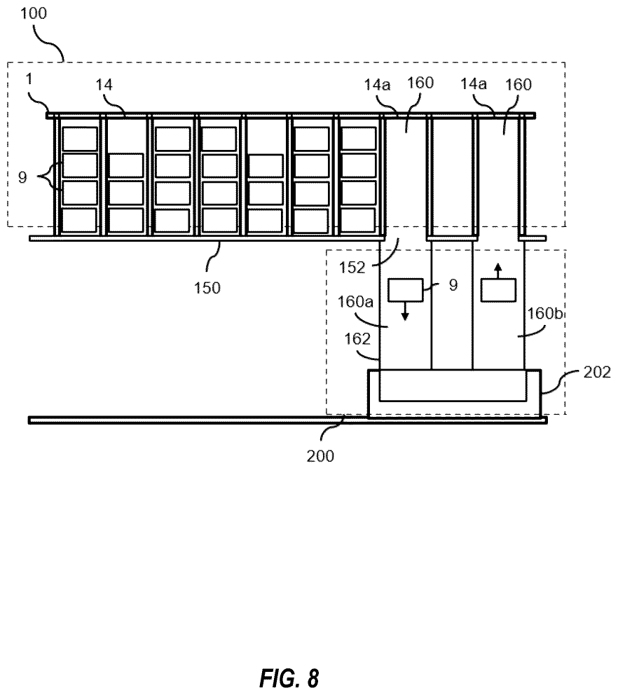

For example, instead of the second zone 200 being located under only a portion of the storage structure 1 via the use of a divider 150, the second zone 200 could be located at a level that is below the whole storage structure 1, as illustrated in FIG. 8. In other words, the divider 150 could be located between the whole storage structure 1 and the second zone 200.

In addition, the passages 160 do not need to extend vertically all the way to a container station 202. The passages could extend downwards to a location remote from a container station 202 and then be transported to the container station 202 in a different direction (e.g. horizontally), e.g. via a conveyor.

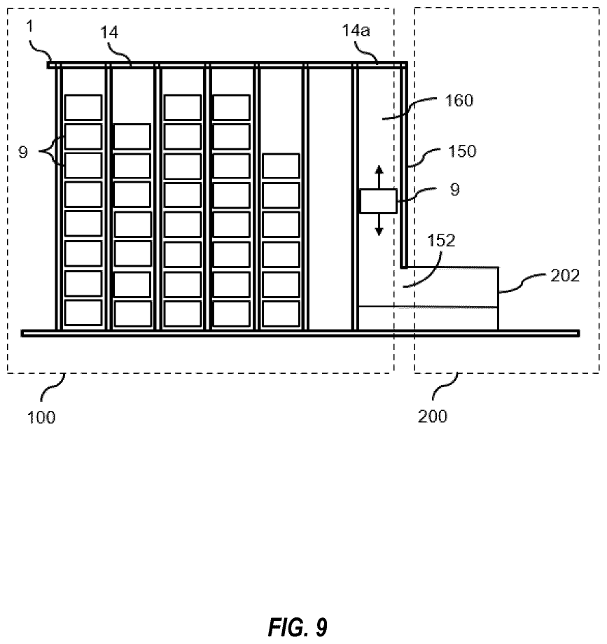

The second zone 200 also does not need to be below the first zone 100. Instead, the second zone 200 could be horizontally adjacent to the first zone 100. In this case, the divider 150 separating the first zone 100 and the second zone 200 could be a vertical wall rather than a floor and the passages could initially extend downwards from a port cell 14a and then horizontally to the second zone 200 via openings 152 in the divider 150. Each passage could comprise a conveyor to transport the storage containers 9 along the horizontal portion of the passage 160. An example of this kind of arrangement is shown in FIG. 9.

What is claimed is:

1. A storage and retrieval system comprising:
a first zone comprising a storage structure, the storage structure comprising:
a plurality of horizontal members arranged to form a first grid pattern defining a plurality of grid cells;
a plurality of upright members configured to support the plurality of horizontal members from below to define a storage area below the plurality of grid cells for storing stacks of storage containers;
a second zone separated from the first zone by a divider, wherein the divider comprises an opening such that the first zone is in fluid communication with the second zone;
a passage extending from an associated grid cell from the plurality of grid cells into the second zone via the opening in the divider such that a storage container can be moved between the first zone and the second zone via the passage; and
a dehumidifier system configured to draw and dehumidify air from the second zone and discharge the air, following dehumidifying, into the first zone.

2. The storage and retrieval system according to claim 1, further comprising a temperature control system configured to maintain a first air temperature in the first zone and a second air temperature in the second zone, wherein the second air temperature is higher than the first air temperature.

3. The storage and retrieval system according to claim 2, wherein the first air temperature is between −30° C. and 0° C.

4. The storage and retrieval system according to claim 3, wherein the first air temperature is between −30° C. and −18° C.

5. The storage and retrieval system of claim 2, wherein the second air temperature is between −10° C. and +8° C.

6. The storage and retrieval system according to claim 5, wherein the second air temperature is between −10° C. and 0° C.

7. The storage and retrieval system of claim 2, wherein the temperature control system comprises a refrigeration system for maintaining the first air temperature in the first zone.

8. The storage and retrieval system of claim 2, wherein the temperature control system comprises a heating system configured to maintain the second air temperature in the second zone.

9. The storage and retrieval system of claim 2, wherein the dehumidifier system is configured to dehumidify the air drawn from the second zone such that a dew point of the air following discharge is lower than the first air temperature.

10. The storage and retrieval system of claim 2, wherein the dehumidifier system is configured to discharge the air, following dehumidifying, into the first zone at a rate such that a positive air pressure is generated in the first zone relative to the second zone.

11. The storage and retrieval system according to claim 1, wherein the dehumidifier system is further configured to draw air from the passage, dehumidify the air drawn from the passage, and discharge the air, following dehumidifying, into the first zone.

12. The storage and retrieval system according to claim 1, wherein the dehumidifier system is configured to draw and mix air from the passage and the air from the second zone in predetermined proportions.

13. The storage and retrieval system of claim 1, wherein the second zone is below at least a portion of the first zone and the passage extends vertically from an associated grid cell from the plurality of grid cells into the second zone.

14. The storage and retrieval system of claim 1, wherein the second zone comprises a container station for receiving a plurality of storage containers such that items can be moved into or out of at least one of the plurality of storage containers, and wherein the passage extends from an associated grid cell from the plurality of grid cells to the container station such that a storage container from the plurality of storage containers can be moved between the storage structure and the container station via the passage.

15. The storage and retrieval system of claim 1, wherein the passage comprises a barrier for selectively opening and closing the passage.

16. The storage and retrieval system of claim 15, wherein the barrier comprises at least one door.

17. The storage and retrieval system of claim 15, wherein the barrier comprises an air curtain unit configured to provide an air curtain across an opening in the passage.

18. The storage and retrieval system of claim 1, wherein at least a portion of the passage is surrounded by a thermally insulating material.

19. The storage and retrieval system of claim 1, wherein the storage and retrieval system comprises a plurality of passages and the divider comprises a plurality of openings, wherein each passage from the plurality of passages extends from an associated grid cell from the plurality of grid cells into the second zone via a respective opening.

20. The storage and retrieval system of claim 1, wherein:
the storage structure further comprises a track structure located on top of the horizontal members,
the track structure comprises a plurality of tracks arranged to form a second grid pattern corresponding to the first grid pattern formed by the plurality of horizontal members, and
the storage and retrieval system further comprises one or more load handling devices, each load handling device comprising:
a driving assembly configured to move a load handling device from the one or more load handling devices on the track structure;
a container-holding assembly configured to releasably hold a storage container from above; and
a lifting assembly configured to raise and lower the container-holding assembly to allow the load handling device to lift and lower the storage container into and out of the storage structure and the passage via the grid cells.
